(19) United States
(12) Patent Application Publication
(10) Pub. No.: US 2009/0240801 A1
(43) Pub. Date: Sep. 24, 2009

(54) Computer data network filter

(76) Inventor: Jonathan Rhoads, (US)

Correspondence Address: Jonathan Rhoads, 280 W Ridge Peak Rd, Oro Valley, AZ, 85737, US

(21) Appl. No.: 12/053,584

(22) Filed: Mar. 22, 2008

(51) Int. Cl. G06F 15/16

(52) U.S. Cl. 709/224

(57) ABSTRACT

An electronic device which connects a network (e.g. the internet) to a subnet (e.g. a home network) for the purpose of filtering the data that moves through the device in order to prevent computers on the subnet from accessing material on the network which may be deemed inappropriate (e.g. pornography). The device contains advanced algorithms that analyze the network traffic to determine the proper configuration of the network device, without the aid of any external peer- or server-based configuration protocols (e.g. Dynamic Host Control Protocol, or DHCP). The device also contains advanced algorithms to determine, apply and update the filter rules with no direct operator authorization or intervention.

### BACKGROUND OF THE INVENTION

1. Field of Invention

This invention relates to computer data networks, and more specifically to filtering the data on the network to remove unwanted or objectionable data.

2. Prior Art

There are currently two general classes of network filters.

The first class of network filters is entirely realized in software, and runs on the computer on which data is to be filtered. Because it runs on the computer that is being filtered, it must be installed using the computer operating system's supplied installation interface, and when updated must use the computer operating system's supplied update methodology. If the installer wants to prevent other computer users from changing the settings, he must provide a password. Generally the installer must also set up at least a minimal set of configuration options, including whether and how often to update its internal database, which network connection to use, and which data sources or types of data should be block. On many current operating systems, there is nothing to prevent an unauthorized user from uninstalling the filter software. Additionally, each computer on the network must have its own copy of the filter software installed and configured.

The other general class of network filters is the network appliance filter. These use general-purpose computers with installed third-party proxy filters. Their configuration is generally manual, and any computers that connect to them generally receive their configuration parameters from some client/server configuration protocol (e.g. DHCP). Additionally, since these servers generally run commercial operating systems, they must be configured and maintained by trained professionals or technicians. Even simple home-oriented hardware filters suffer from undue complexity in the sense that they generally require software to be installed on the network computer to work correctly.

The filters described in the preceding paragraph have the advantage, however, of protecting the whole computer network, and not just an individual computer on the network. They have the added advantage of filtering the network data traffic independent of the connected computers, so those computers cannot circumvent the filter.

Neither of these filter classes provides the coverage, security, and ease of use that a general untrained computer user would require to protect his network. For example, if a home network owner has more than one computer on his home network, he or she would be required to purchase or otherwise license more than one copy of filter software to protect his or her computers. In some cases, filter software may not be available for his or her computer's operating system. Alternatively, the home network owner will unlikely be in the position to purchase and configure a dedicated appliance. If he or she does purchase one, the dedicated appliances available today require software installation on each computer on the subnet to function correctly, which accrues the same difficulties as the software filters, described above.

This invention provides a third class of filter product. It filters the network, and not the computer. It installs and configures itself. It downloads and applies updates without any user intervention. It does not require any software to be installed on the user's computer, thereby eliminating licensing and compatibility issues. Finally in its alternative embodiment, it contains a physically secured compartment in which to secure a network modem, to improve security against unauthorized circumvention.

### BACKGROUND OF THE INVENTION—OBJECTS AND ADVANTAGES

Accordingly several objects and advantages of this invention are as follows:

First, since the entire network is filtered, and not just a particular computer on the network, the operating system of each computer on the network is immaterial. Additionally, the number of computers, up to the physical capacity of the filter internal processor, is immaterial.

The independence of the network filter from any particular computer on the network is also beneficial because it renders attempts to circumvent the filter ineffective. Additionally, since the filter does not have an externally recognizable network address, it is not possible to circumvent the filter via standard network-centric protocols.

Secondly, since the filter installs and configures itself, the user does not have to have any special knowledge or expertise. Equally important, since the filter does not rely on peer- or server-centric configuration protocols, its configuration occurs transparently to the network devices connected to the filter's network interfaces. This allows the filter to work even with network hardware that requires specific matching computer hardware to function properly (e.g. a cable modem and a specific cable-company supplied network card).

Thirdly, since this filter does not require any setup, no software must be installed on the user's computer. No password needs to be set up. Not filter categories have to be defined. In short, the filter operation is truly and completely transparent to the user.

Fourthly, the physically secured compartment (in the alternative embodiment) inside the filter allows the user to secure network equipment (e.g. a cable or Digital Subscriber Line modem) inside the filter, making it difficult for an unauthorized user (e.g. a child) to physically circumvent the filter.

### SUMMARY

This invention is aimed at filtering computer data networks for undesirable content in a uniquely secure, complete, and unobtrusive way, while requiring no configuration, setup, or input of any kind from the user.

### DRAWINGS—FIGURES

FIG. 1 Illustrates a top view of the filter.

FIG. 2 Illustrates a front view of an alternative form factor, which includes space into which a network device may be secured.

FIG. 3 Illustrates a side view of an alternative form factor, which includes space into which a network device may be secured.

FIG. 4 Illustrates the various system components in order to demonstrate where the filter fits into the network.

### DETAILED DESCRIPTION—PREFERRED EMBODIMENT

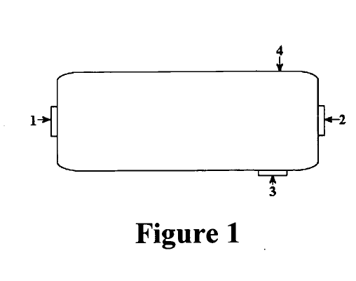

FIG. 1 shows the top view of the filter. The main body of the filter is represented by 4. On one side of the filter is a network interface 1 that interfaces to the network that is unfiltered. On the other side of the filter is a network interface 2 that interfaces to the network that is filtered. Anything that connects to 2, including, but not limited to, a computer or a router, will be unable to access data that has been filtered by the filter. A power cord plugs into the power jack 3.

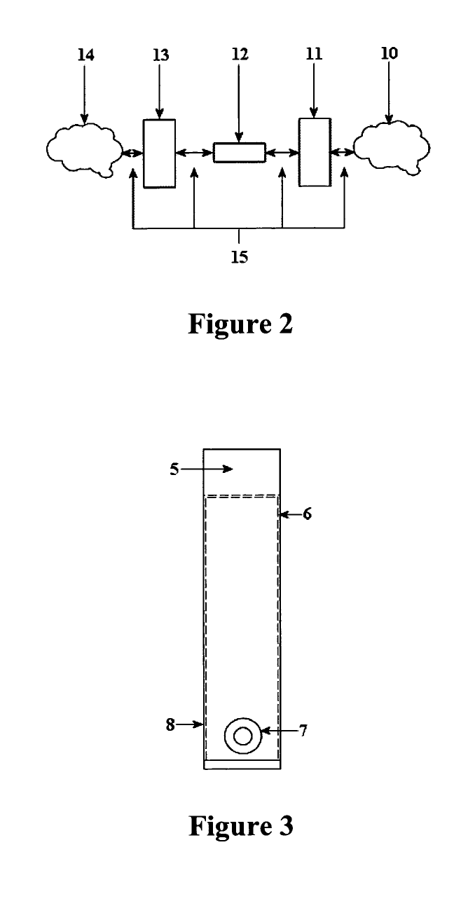

FIG. 2 shows the various system components in order to demonstrate where the filter fits into the network. The unfiltered network 10 (e.g. the internet) connects to some local network device 11 (e.g. a cable modem). This network device connects to the filter 12, which in turn connects to another network device 13, which can be either a computer or a network switch. The local filtered network 14 can be either a single computer, or a set of computers organized in a subnet.

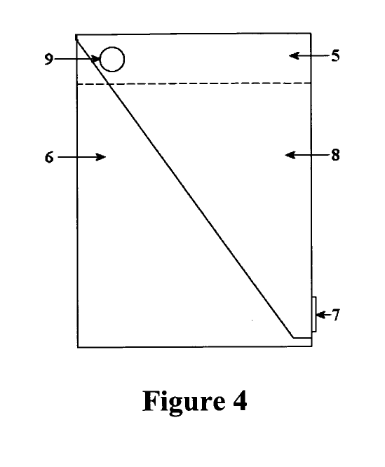

### Operation: FIGS. 1-4

The operation of the filter will be as follows:

The first phase of operation is filter installation. The installation process consists of connecting the unfiltered network 10 (e.g. an Ethernet cable which connects to the internet) to network interface 2 (usually via a network device 11), and the filtered network 14 (e.g. an Ethernet cable which connects to a local router) to network interface 3 (optionally via a network device 13) on the filter, and then plugging the power cord into the filter at 3. Once the filter is plugged in, it will compare its current system software and databases to the current baseline versions on a remote server. If there is a difference, the filter will download and install the new baseline software packages and databases. It will then observe network traffic to ascertain the data-link and network layer address of the devices 11 and 13 connecting to the filter. The filter will then use these addresses to communicate with the externally connected network devices 11 and 13. Finally, the filtering computer program will begin running in order to filter the data that passes through the device.

The second phase of the operation is the continuing operation of the filter. In this phase, a computer connected to the filtered subnet 14 will make a network request through the filtered network interface 2. The filter will determine if the request is valid, according to pre-programmed criteria. If the request is valid, then it will be passed onto the unfiltered network 10 via interface 1. The return data will be checked, again according to pre-programmed criteria. If the return data is valid, then it will pass back through interface 2 to the subnet 14.

### Alternative Embodiment

FIG. 2 shows a front view of an alternative form factor which includes a securable space into which any other network equipment, for example a cable or digital subscriber line (DSL) modem, or a router, can be placed. The filter electronics are contained in the compartment 5. The network equipment can be placed into compartment 6. Finally, a hinged door 8 can be closed over the equipment, and secured with a lock or other physical security device 7.

FIG. 3 shows a side view of an alternative form factor which includes a securable space as described above in the “Objects and Advantages” section. In addition to the box, the compartment, the door and the physical security device, this figure shows a hinge 9 which connects the door to the box.

### Conclusion, Ramifications, and Scope

Accordingly, the reader can see that there are two unique and valuable advantages to the network filter that I have described here. The first is that since the network filter configures itself without the need for client software, server- or peer-based network protocols, or operator intercession for the purpose of assigning a password, setting filter parameters, or updating the software or databases, the filter can be used with confidence by any user regardless of his or her technical experience or sophistication, while eliminating the likelihood that the filter function can be circumvented by uninstalling the client software, guessing the password, or otherwise undermining the function of the client software.

The second advantage is that since the filter (in its alternative embodiment) has space to enclose network equipment in a locked or otherwise entry-restricted compartment, the likelihood that the filter will be undermined through physically disconnecting it or otherwise physically tampering with the filter will be significantly reduced.

I claim:

1. A method for transparently inserting an interloping network filter on a computer network line which connects two computer network-enabled devices for the purpose of filtering the data passing between the two devices, comprising the steps of
a. Physically inserting the said network filter on the line between the two network devices,
b. observing the data being exchanged between the two network devices to ascertain the data-link and network layer address of the devices being interloped,
c. reading the data into the device from one side of the interloped line and processing the data as required,
d. retransmitting the data on the other end of the interloped line using the network addresses previously ascertained,

2. A structure of an auto-configuring network filter comprising:
a. Interfaces connecting to a network and sub-network (sub-net),
b. A general-purpose digital computer,
c. Software so written as to preclude the need to manually configure the filter in any way,

3. The method of claim 2 wherein the network interface is a physical connection,

4. The method of claim 2 wherein the network interface is a wireless connection,

5. The method of claim 2 wherein the filter ascertains its own data-link and network-layer addresses without operator or server-based intervention,

6. The method of claim 2 wherein all the filter parameters and databases are set without any operator intervention,

7. The method of claim 2 wherein the filter operation is not dependent on the installation of on any computer on the sub-net.

8. A structure of a physically secured network filter comprising
a. Interfaces connecting to a network and a sub-network (sub-net),
b. A general-purpose digital computer,
c. Software so written as to filter data flowing between the network and the sub-net,
d. A physical enclosure enclosing the said network interfaces and general purpose digital computer, with sufficient space to also include at least one network device.

9. The method of claim 8 wherein the network interface is a physical connection,

10. The method of claim 8 wherein the network interface is a wireless connection,

11. The method of claim 8 wherein the physical enclosure encloses a cable modem,

12. The method of claim 8 wherein the physical enclosure encloses a digital subscriber line (DSL) modem,

13. The method of claim 8 wherein the physical enclosure encloses a network switch,

14. The method of claim 8 wherein the physical enclosure contains a locking mechanism with the intent of hindering unauthorized access to the enclosed network device.
